(19) United States
(12) Patent Application Publication
(10) Pub. No.: US 2009/0225821 A1
(43) Pub. Date: Sep. 10, 2009

(54) METHODS AND APPARATUS TO DETECT AN IMBALANCED SUBSCRIBER LINE IN A DIGITAL SUBSCRIBER LINE (DSL) SYSTEM

(76) Inventors: Hua Jiao, Pleasanton, CA (US); Jin Wang, Fremont, CA (US); Kapil Shrikhande, Berkeley, CA (US)

Correspondence Address: AT&T Legal Department - HFZ;ATTN. Patent Docketing, One AT&T Way, Room 2A-207, Bedminstor, NJ, 07921, US

(21) Appl. No.: 12/041,928

(22) Filed: Mar. 4, 2008

(51) Int. Cl. H04B 3/46; H04B 17/00

(52) U.S. Cl. 375/225

(57) ABSTRACT

Methods and apparatus to detect an imbalanced subscriber line in a digital subscriber line (DSL) system are disclosed. An example method comprises identifying a contiguous set of performance parameters in a plurality of performance parameters for respective ones of a plurality of DSL sub-carriers of a subscriber line associated with a DSL modem, the identified set have values representative of degraded performance and corresponding to an operating frequency of a geographically proximate AM interference source. The example method further comprises comparing a number of DSL sub-carriers contained in the identified set with a threshold to determine whether the subscriber line has an imbalanced condition.

### FIELD OF THE DISCLOSURE

This disclosure relates generally to digital subscriber line (DSL) systems and, more particularly, to methods and apparatus to detect an imbalanced subscriber line in a DSL system.

### BACKGROUND

Communication systems using digital subscriber line (DSL) technologies are commonly utilized to provide Internet related services to subscribers, such as, homes and/or businesses (also referred to herein collectively and/or individually as users, customers and/or customer-premises). DSL technologies enable customers to utilize telephone lines (e.g., ordinary twisted-pair copper telephone lines used to provide Plain Old Telephone System (POTS) services) to connect the customer to, for example, a high data-rate broadband Internet network, broadband service and/or broadband content. For example, a communication company and/or service provider may utilize a plurality of modems (e.g., a plurality of DSL modems) implemented by a DSL Access Multiplexer (DSLAM) at a central office (CO) to provide DSL communication services to a plurality of modems located at respective customer-premises. In general, a CO DSL modem receives broadband service content from, for example, a backbone server and forms a digital downstream DSL signal to be transmitted to a customer-premises DSL modem. Likewise, the CO DSL modem receives an upstream DSL signal from the customer-premises DSL modem and provides the data transported in the upstream DSL signal to the backbone server.

AM noise interference arises from commercial radio stations that, regularly and/or intermittently, broadcast radio frequency (RF) signals within the frequency band from 560 thousand cycles per second (kHz) to 1.6 million cycles per second (MHz). AM noise interference may, additionally or alternatively, also arise from handheld amateur radio (HAM) transmitters. DSL modems transmit signals on subscriber lines within the frequency band from 138 kHz to upwards of 30 MHz. RF signals that fall incident upon a subscriber line may, in some instances, induce charge flux and/or voltages with respect to ground. Such influences may occur in either aerial or buried subscriber lines. The effects of the AM noise interference depend upon the strength and/or distance between the RF signal source and the subscriber line.

### BRIEF DESCRIPTION OF THE DRAWINGS

FIG. 1 is a schematic illustration of an example digital subscriber line (DSL) communication system constructed in accordance with the teachings of the disclosure.

FIGS. 2A-C are graphs illustrating example performance parameters for the example subscriber lines of FIG. 1 under different operating conditions.

FIG. 3 illustrates an example manner of implementing the example DSL diagnostic tool of FIG. 1.

FIG. 4 illustrates an example manner of implementing the example data analysis module of FIG. 4.

FIG. 5 is a flowchart representative of example machine accessible instructions that may be carried out by, for example, a processor to implement any or all of the example DSL diagnostic tools of FIGS. 1 and/or 3.

FIG. 6 is a schematic illustration of an example processor platform that may be used and/or programmed to execute the example machine accessible instructions of FIG. 5 to implement any or all of the example DSL diagnostic tools described herein.

### DETAILED DESCRIPTION

Methods and apparatus to detect an imbalanced subscriber line in a digital subscriber line (DSL) system are disclosed. A disclosed example method includes identifying a contiguous set of performance parameters in a plurality of performance parameters for respective ones of a plurality of DSL sub-carriers of a subscriber line associated with a DSL modem, the identified set have values representative of degraded performance and corresponding to an operating frequency of a geographically proximate AM interference source. The disclosed example method further includes comparing a number of DSL sub-carriers contained in the identified set with a threshold to determine whether the subscriber line has an imbalanced condition.

Another disclosed example method includes identifying a contiguous set of performance parameters in a plurality of performance parameters for respective ones of a plurality of frequencies of a subscriber line associated with a DSL modem, the identified set having values representative of both an AM radio interference and an imbalanced condition associated with the subscriber line. The disclosed example method further includes automatically generating a trouble ticket for the subscriber line when the identified set of performance parameters corresponds to an operating frequency of a geographically proximate AM interference source.

A disclosed example apparatus includes a database interface module to obtain a plurality of performance parameters for respective ones of a plurality of transmission frequencies of a subscriber loop associated with a DSL modem, a thresholder to determine whether a contiguous set of the plurality of performance parameters having degraded values corresponds to both AM interference and an imbalanced condition associated with the subscriber loop, an AM source location analyzer to verify that the set of performance parameters corresponds to an operating frequency of an AM source transmitting in geographic proximity to the subscriber loop, and a trouble ticket submitter to request a repair ticket for the subscriber loop when the identified set of performance parameters corresponds to the operating frequency of the AM source.

While methods and apparatus to detect an imbalanced subscriber line in a DSL system are described herein, the example methods and apparatus may, additionally or alternatively, be used to detect other types of interference and/or wiring faults in other types of communication systems. Other example systems include, but are not limited to, those associated with public switched telephone network (PSTN) systems, public land mobile network (PLMN) systems (e.g., cellular), wireless distribution systems, wired or cable distribution systems, coaxial cable distribution systems, Ultra High Frequency (UHF)/ Very High Frequency (VHF) radio frequency systems, satellite or other extra-terrestrial systems, cellular distribution systems, power-line broadcast systems, fiber optic networks, passive optical network (PON) systems, and/or any combination and/or hybrid of these devices, systems and/or networks.

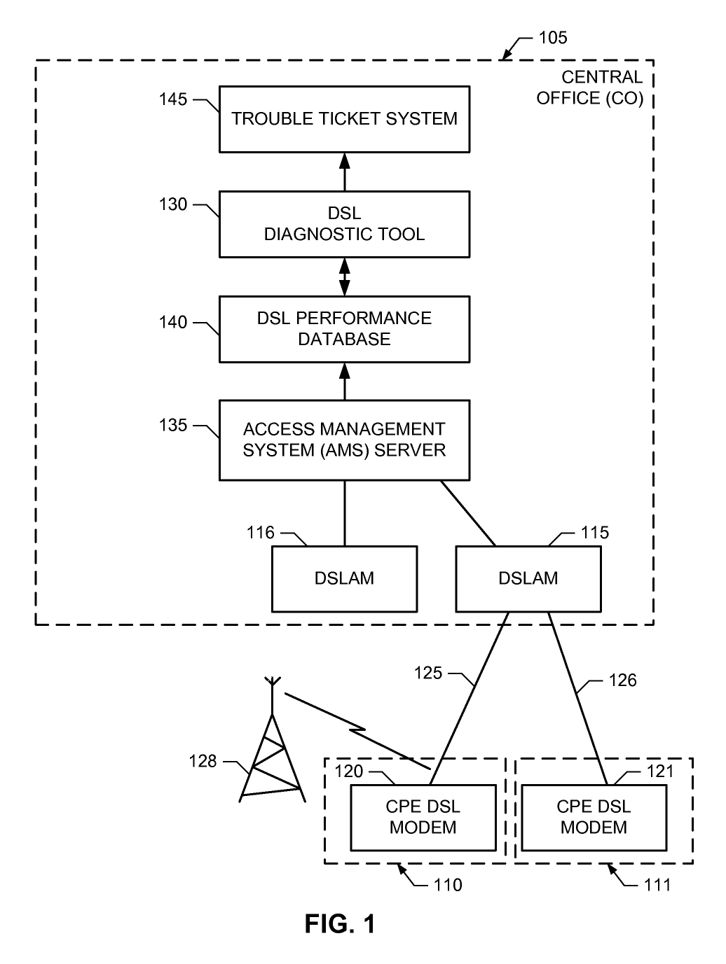

FIG. 1 illustrates an example DSL communication system in which a central office (CO) 105 provides data and/or communication services (e.g., telephone services, Internet services, data services, messaging services, instant messaging services, electronic mail (email) services, chat services, video services, audio services, gaming services, etc.) to one or more customer premises, two of which are designated at reference numerals 110 and 111. To provide DSL communication services to the customer premises 110 and 111, the example CO 105 of FIG. 1 includes any number and/or type(s) of DSL access multiplexers (DSLAMs) (two of which are designated at reference numerals 115 and 116), and the example customer premises 110 and 111 include any type(s) of customer-premises equipment (CPE), such as DSL modems 120 and 121. The example DSLAMs 115 and 116 of FIG. 1 include and/or implement one or more CO DSL modems (not shown) for respective ones of the customer-premises locations 110 and 111. The example DSLAMs 115 and 116, the CO DSL modems within the DSLAMs 115 and 116, and/or the example CPE DSL modems 120 and 121 of FIG. 1 may be implemented, for example, in accordance with the International Telecommunications Union-Telecommunications Sector (ITU-T) G.993.x family of standards for very high-speed DSL (VDSL), and/or the ITU-T G.992.x family of standards for asymmetric DSL (ADSL).

In the illustrated example of FIG. 1, the DSLAM 115 provides DSL services to the DSL modems 120 and 121 via respective subscriber lines 125 and 126. Subscriber lines are sometimes also referred to in the industry as “wire-pairs”, “subscriber loops” and/or “loops.” While throughout this disclosure reference is made to the example subscriber lines 125 and/or 126 of FIG. 1, a subscriber line (e.g., any of the example subscriber lines 125 and 126) used to provide a DSL service to a customer-premises location (e.g., any of the locations 110 and 111) may include and/or be constructed from one or more segments of twisted-pair telephone wire (e.g., a combination of a feeder one (F1) cable, a distribution cable, a drop cable, and/or customer-premises wiring), terminals and/or distributions points (e.g., a serving area interface (SAI), a serving terminal, a vault and/or a pedestal). Such segments of twisted-pair telephone wire may be spliced and/or connected end-to-end, and/or may be connected at only one end thereby creating one or more bridged-taps. Regardless of the number, type(s), gauge(s) and/or topology of twisted-pair telephone wires used to construct the example subscriber lines 125 and 126, they will be referred to herein in the singular form, but it will be understood that the term “subscriber line” may refer to one or more twisted-pair telephone wire segments and may include one or more bridged taps.

In traditional DSL communication systems, wiring faults, interference, noise and/or performance problems are diagnosed and/or resolved once a subscriber contacts a customer service and/or technical support line to report a problem for a particular subscriber line. Moreover, such problems must often be resolved without the benefit of complete and/or precise technical information about the type of problem(s) that may be affecting the subscriber line. Such traditional processes can result in decreased customer satisfaction and may be unable to properly correct reported problems when, for example, the source of a reported problem is intermittent in nature.

In contrast, the methods and apparatus described herein proactively monitor and/or review the performance parameters of all subscriber lines (e.g., the example subscriber lines 125 and 126) of a CO (e.g., the example CO 105) at periodic or aperiodic intervals to detect performance degradation caused by AM interference noise, and one or more wiring faults that, for example, result in an imbalanced subscriber line condition. Example imbalanced conditions include, but are not limited to, a resistive imbalance, a capacitive imbalance, a phase imbalance, and/or a longitudinal imbalance. Example wiring faults that may result in an imbalanced subscriber line condition include, but are not limited to, bad customer-premises wiring, a cable fault, a bad connection, a bad splice, a bad connector, a bonding issue and/or a grounding issue. Once such interference and/or wiring faults are identified, a trouble and/or repair ticket is automatically generated such that a service technician can identify and/or mitigate the issue, sometimes prior to a subscriber becoming aware and/or reporting that a problem exists. In this way, a service provider can enhance the quality of the DSL services provided via the CO 105 and the subscriber's perception of the same.

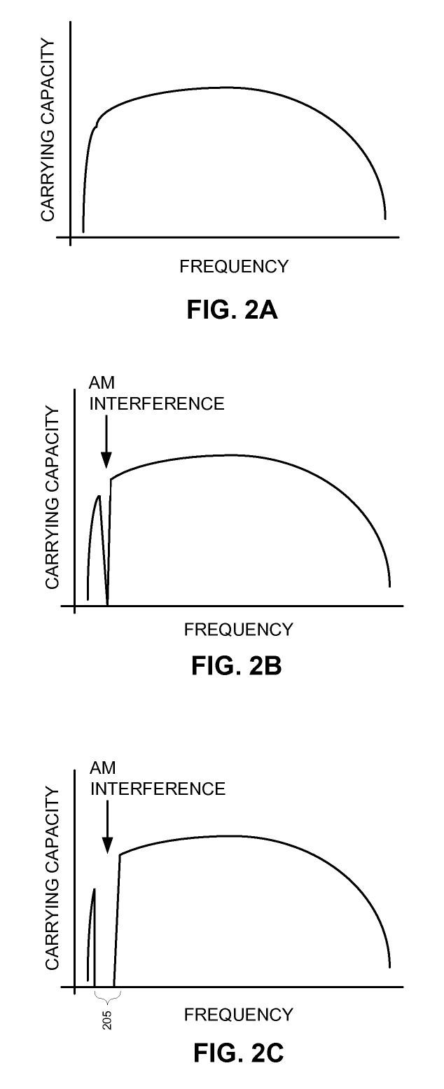

FIG. 2A is a graph illustrating example performance parameters for a subscriber line (e.g., the example subscriber line 125 of FIG. 1) while operating under normal conditions (e.g., no AM interference noise and a balanced subscriber line). As illustrated in FIG. 2A, the subscriber line 125 has information carrying capacity that varies across a range of frequencies (e.g., DSL sub-carriers). The information carrying capacity depends upon the characteristics of the subscriber line 125 (e.g., the frequency dependent attenuation of the subscriber line 125, ambient noise, etc.) as well as the operating bandwidth(s) of the DSL modems communicating via the subscriber line 125. Information carrying capacity can be, for example, expressed in units of bits per DSL sub-carrier, signal-to-noise ratio (SNR) and/or noise power.

FIG. 2B is a graph illustrating example performance parameters for the same subscriber line while operating in the presence of a geographically proximate AM interference source (e.g., the example AM radio station 128 of FIG. 1). As illustrated in FIG. 2B, the subscriber line 125 has degraded information carrying capacity at frequencies near the operating and/or broadcast frequency (e.g., 500 kHz) of the AM interference source 128. Because the example of FIG. 2B corresponds to a balanced subscriber line, the performance degradation caused by the AM interference source is restricted to a narrow band of frequencies (e.g., one or two DSL sub-carriers).

In contrast to the example of FIG. 2B, the example performance parameter graph illustrated in FIG. 2C occurs when the same subscriber line is an imbalanced subscriber line. As illustrated in FIG. 2C, a substantially larger number of DSL sub-carriers (e.g., ten, twenty and/or forty DSL sub-carriers) exhibit performance degradation, as compared to FIG. 2B, due to the subscriber line being imbalanced. In particular, a contiguous set of frequencies 205 have performance degradation (e.g., no information carrying capacity) in the example of FIG. 2C. The contiguous set of frequencies 205 is substantially larger than the narrow set of frequencies that would be impacted by an AM interference source were the subscriber line properly balanced compared to FIG. 2B. Moreover, the contiguous set of frequencies 205 corresponds to the operating and/or broadcast frequency of the AM interference source (e.g., are centered and/or distributed about the operating frequency). As illustrated in FIG. 2C, an imbalanced subscriber line can be identified by detecting a substantially and/or significantly large number of affected contiguous DSL sub-carriers that correspond to an AM interference source that is nearby and/or geographically proximate to the subscriber line (e.g., within two or three miles of the subscriber line).

Returning to FIG. 1, to proactively monitor and/or diagnosis a subscriber line (e.g., one of the example subscriber lines 125 and 126), the example DSL communication system of FIG. 1 includes a DSL diagnostic tool 130. Based on a schedule (e.g., hourly, daily, weekly, etc.) the example DSL diagnostic tool 130 of FIG. 1 automatically analyzes historical and/or current performance data associated with each of the subscriber lines 125 and 126, for example, as collected from the example DSLAMs 115 and 116 by an access management system (AMS) server 135 and stored in a performance database 140. Using the performance data obtained from the DSL performance database 140 (e.g., bits per DSL sub-carrier, SNR and/or noise power), the example DSL diagnostic tool 130 attempts to identify whether a subscriber line 125, 126 is an imbalanced subscriber line by searching for a large contiguous set of degraded frequencies (e.g., the example contiguous frequencies 205 of FIG. 2C) that correspond to a nearby and/or geographically proximate AM interference source (e.g., the example AM radio station transmitter 128).

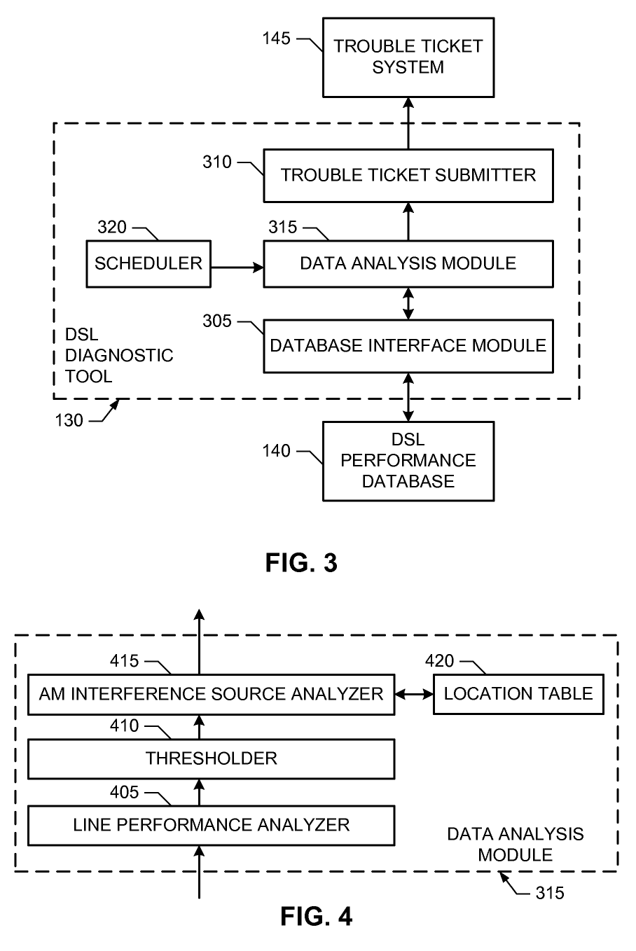

When an imbalanced subscriber line is identified, the example DSL diagnostic tool 130 of FIG. 1 automatically generates and/or submits a repair ticket to a trouble ticket system 145 so that an appropriate technician can be dispatched to locate, mitigate and/or resolve the problem by, for example, installing a common-mode choke, installing an inline filter, replacing a cable, grounding the subscriber line, repairing a connection, and/or replacing a connector. An example manner of implementing the example DSL diagnostic tool 130 of FIG. 1 is described below in connection with FIGS. 3 and/or 4.

To collect performance data, the example CO 105 of FIG. 1 includes the example AMS server 135. The example AMS server 135 of FIG. 1 periodically or aperiodically collects performance data (e.g., maximum attainable data rates, error counters, estimated loop lengths, DSL connection rates, loop attenuation values, error rates, signal-to-noise ratios, bit allocations, noise margins, DSL modem configurations, etc.) from the example DSLAMs 115 and 116 and/or customer-premises DSL modems 120 and 121 communicatively coupled to the DSLAMs 115 and 116.

To manage repair and/or maintenance reports, the example CO 105 of FIG. 1 includes the example trouble ticket system 145. The example trouble ticket system 145 of FIG. 1 implements an application programming interface (API) via which the example DSL diagnostic tool 130 can submit a trouble ticket. The example trouble ticket system 145 also routes a submitted trouble ticket to a suitable repair, customer support and/or technical support person for resolution, and tracks the resolution of trouble tickets.

While in the illustrated example of FIG. 1, the example DSLAMs 115 and 116, the example DSL diagnostic tool 130, the example AMS server 135, the example DSL performance database 140, and the example trouble ticket system 145 are illustrated in connection with the example CO 105, one or more of the DSL diagnostic tool 130, the example AMS server 135, the example DSL performance database 140, and/or the example trouble ticket system 145 may be located and/or implemented separately from the CO 105. For example, the DSL diagnostic tool 130, the example DSL performance database 140, and/or the example trouble ticket system 145 may be located and/or implemented at a customer service location (not shown), which is communicatively coupled to the AMS 135 at the CO 105. Further any number of DSLAMs 115 and 116 may be implemented and/or located at a CO. Moreover, a DSLAM 115, 116 may be implemented and/or located at a remote terminal (not shown), which is communicatively coupled to the example DSL diagnostic tool 130 via an AMS server (e.g., the example AMS server 135 at a CO (e.g., the example CO 105).

FIG. 3 illustrates an example manner of implementing the example DSL diagnostic tool 130 of FIG. 1. To interact with the example performance database 140, the example DSL diagnostic tool 130 of FIG. 3 includes a database interface module 305. The example database interface module 305 of FIG. 3 implements one or more APIs to allow other elements of the example DSL diagnostic tool 130 to perform queries of the example performance database 140 to, for example, obtain performance data associated with a subscriber loop.

To interact with the example trouble ticket system 145, the example DSL diagnostic tool 130 of FIG. 3 includes a trouble ticket submitter 310. The example trouble ticket submitter 310 of FIG. 3 submits repair tickets for serving terminals and/or subscriber lines identified by a data analysis module 315. The example trouble ticket submitter 310 submits a trouble ticket by, for example, accessing and/or utilizing an API provided and/or implemented by the example trouble ticket system 145. In some examples, the trouble ticket submitter 310 includes diagnostic data (e.g., how many frequencies were affected, which frequencies were affected, time of day when the frequencies were affected, etc.) as part of a submitted trouble ticket. Such included information may be used by, for example, a repair technician while diagnosing and/or repairing a detected problem.

To analyze performance data, the example DSL diagnostic tool 130 of FIG. 3 includes a data analysis module 315 and a scheduler 320. The example scheduler 320 of FIG. 3 directs the example data analysis module 315 to periodically or aperiodically analyzes historical and/or current performance data stored in the DSL performance database 140. The times set by the scheduler 320 may be programmed by a technician.

Using the performance data obtained from the DSL performance database 140 (e.g., bits per DSL sub-carrier, SNR and/or noise power), the example data analysis module 315 of FIG. 3 attempts to identify imbalanced subscriber lines affected by an AM interference source by searching for a large contiguous set of degraded frequencies (e.g., forty frequencies) that correspond to a nearby and/or geographically proximate AM interference source (e.g., the example AM radio station transmitter 128 of FIG. 1).

When an imbalanced subscriber line is identified, the example data analysis module 315 notifies the example trouble ticket submitter 310. The trouble ticket submitter 320 responds by automatically submitting a repair ticket to the trouble ticket system 145 so that an appropriate technician can be dispatched to locate, mitigate and/or resolve the problem (e.g., by installing a common-mode choke, installing an inline filter, replacing a cable, grounding the subscriber line, repairing a connection, and/or replacing a connector). An example manner of implementing the example data analysis module 315 of FIG. 3 is described below in connection with FIG. 4.

While an example manner of implementing the example DSL diagnostic tool 130 of FIG. 1 has been illustrated in FIG. 3, one or more of the elements, processes and/or devices illustrated in FIG. 3 may be combined, divided, re-arranged, omitted, eliminated and/or implemented in any other way. Further, the example database interface module 305, the example trouble ticket submitter 310, the example data analysis module 315, the example scheduler 320 and/or, more generally, the example DSL diagnostic tool 130 of FIG. 3 may be implemented by hardware, software, firmware and/or any combination of hardware, software and/or firmware. Thus, for example, any or the example database interface module 305, the example trouble ticket submitter 310, the example data analysis module 315, the example scheduler 320 and/or, more generally, the example DSL diagnostic tool 130 may be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software implementation, at least one of the example database interface module 305, the example trouble ticket submitter 310, the example data analysis module 315, the example scheduler 320 and/or, more generally, the example DSL diagnostic tool 130 are hereby expressly defined to include a tangible medium such as a memory, a digital versatile disc (DVD), a compact disc (CD), etc. Further still, the example DSL diagnostic tool 130 may include one or more elements, processes and/or devices in addition to, or instead of, those illustrated in FIG. 3, and/or may include more than one of any or all of the illustrated elements, processes and devices.

FIG. 4 illustrates an example manner of implementing the example data analysis module 315 of FIG. 3. To identify subscriber lines having one or more contiguous sets of degraded frequencies and/or DSL sub-carriers, the example data analysis module 315 of FIG. 4 includes a line performance analyzer 405. The example line performance analyzer 405 of FIG. 4 processes one or more performance data records (e.g., each containing bit allocation, SNR and/or noise power data for a plurality of frequencies and/or DSL sub-carriers) for each subscriber line of a CO to create a list of subscriber lines having at least one contiguous set of degraded frequencies and/or DSL sub-carriers.

To identify potentially imbalanced subscriber lines, the example data analysis module 315 of FIG. 4 includes a thresholder 410. For each subscriber line identified by the example line performance analyzer 405, the example thresholder 410 of FIG. 4 compares the number of frequencies and/or DSL sub-carriers in each contiguous set(s) of degraded frequencies and/or DSL sub-carriers to a threshold (e.g., forty). If a subscriber line is associated with a large contiguous set of degraded frequencies and/or DSL sub-carriers, the subscriber line is identified by the thresholder 410 as a potentially imbalanced subscriber line.

To correlate potentially imbalanced subscriber lines with AM interference noise sources, the example data analysis module 315 of FIG. 4 includes an AM interference source analyzer 415. For each subscriber line identified by the example thresholder 410, the example AM interference source analyzer 415 of FIG. 4 compares the contiguous set(s) of degraded frequencies and/or DSL sub-carriers with the operating and/or broadcast frequency(-ies) of any nearby AM interference sources. If any of the set(s) of degraded frequencies and/or DSL sub-carriers of a subscriber line correspond to a nearby AM interference source (e.g., are generally centered around the AM broadcast frequency), the example AM interference source analyzer 415 notifies the example trouble ticket submitter 310 of FIG. 3 that the presently considered subscriber line is imbalanced and in need of repair and/or maintenance. To facilitate this determination, the AM interference source analyzer 415 is in communication with a location table 420 of AM broadcast frequencies and the geographic locations of the corresponding broadcast transmitters.

To store AM interference source information, the example data analysis module 315 of FIG. 4 includes the example location table 420. The example location table 420 of FIG. 4 stores for a plurality of AM interference sources an operating and/or broadcast frequency and a geographic location. In some instances, the example location table 420 only stores AM interference source information for AM interference sources located within a geographic region that includes the DSLAMs, subscriber lines and/or DSL modems being analyzed by the example data analysis module 315 and/or, more generally, the example DSL diagnostic tool 130. The example location table 420 of FIG. 1 may be implemented using any number and/or type(s) of data structures, and/or may stored in any number and/or type(s) of memory(-ies) and/or memory devices.

While an example manner of implementing the example data analysis module 315 of FIG. 3 has been illustrated in FIG. 4, one or more of the elements, processes and/or devices illustrated in FIG. 4 may be combined, divided, re-arranged, omitted, eliminated and/or implemented in any other way. Further, the example line performance analyzer 405, the example thresholder 410, the example AM interference source analyzer 415, the example location table 420 and/or, more generally, the example data analysis module 315 of FIG. 4 may be implemented by hardware, software, firmware and/or any combination of hardware, software and/or firmware. Thus, for example, any or the example line performance analyzer 405, the example thresholder 410, the example AM interference source analyzer 415, the example table 420 and/or, more generally, the example data analysis module 315 may be implemented by one or more circuit(s), programmable processor(s), ASIC(s), PLD(s) and/or FPLD(s), etc. When any of the appended claims are read to cover a purely software implementation, at least one of the example line performance analyzer 405, the example thresholder 410, the example AM interference source analyzer 415, the example location table 420 and/or, more generally, the example data analysis module 315 are hereby expressly defined to include a tangible medium such as a memory, a DVD, a CD, etc. Further still, the example analysis module 315 of FIG. 4 may include one or more elements, processes and/or devices in addition to, or instead of, those illustrated in FIG. 4, and/or may include more than one of any or all of the illustrated elements, processes and devices.

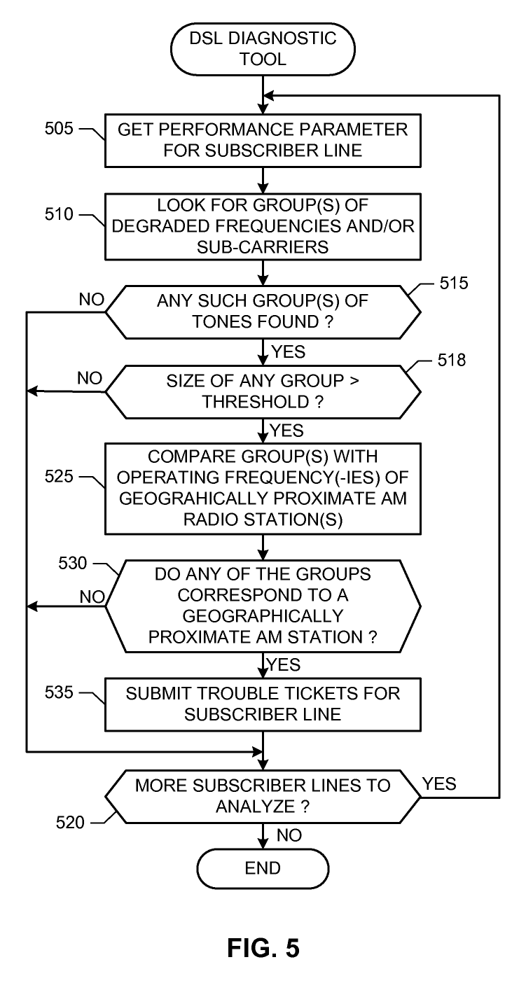

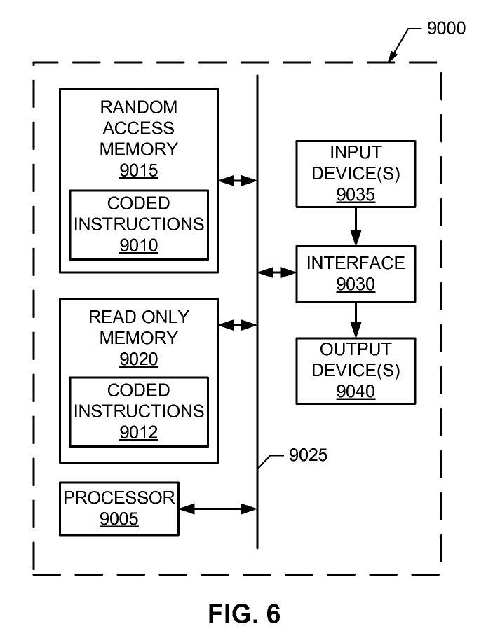

FIG. 5 is a flowchart representative of example machine accessible instructions that may be carried out to implement any or all of the example DSL diagnostic tools 130 of FIGS. 1 and/or 3. The example machine accessible instructions of FIG. 5 may be carried out by a processor, a controller and/or any other suitable processing device. For example, the example machine accessible instructions of FIG. 5 may be embodied in coded instructions stored on a tangible medium such as a flash memory, a read-only memory (ROM) and/or random-access memory (RAM) associated with a processor (e.g., the example processor 9005 discussed below in connection with FIG. 6). Alternatively, some or all of the example machine accessible instructions of FIG. 5 may be implemented using any combination(s) of circuit(s), ASIC(s), PLD(s), FPLD(s), discrete logic, hardware, firmware, etc. Also, some or all of the example machine accessible instructions of FIG. 5 may be implemented manually or as any combination of any of the foregoing techniques, for example, any combination of firmware, software, discrete logic and/or hardware. Further, although the example operations of FIG. 5 are described with reference to the flowchart of FIG. 5, many other methods of implementing the operations of FIG. 5 may be employed. For example, the order of execution of the blocks may be changed, and/or one or more of the blocks described may be changed, eliminated, sub-divided, or combined. Additionally, any or all of the example machine accessible instructions of FIG. 5 may be carried out sequentially and/or carried out in parallel by, for example, separate processing threads, processors, devices, discrete logic, circuits, etc.

The example machine accessible instructions of FIG. 5 begin when the example scheduler 320 of FIG. 3 directs the example DSL diagnostic tool 315 to process performance data to identify imbalanced subscriber lines. The example data interface module 305 queries the example DSL performance database 140 of FIG. 1 to obtain performance parameters (e.g., number of bits allocated per DSL sub-carrier for a plurality of DSL sub-carriers) from a performance data record for a presently considered subscriber line (block 505).

The example line performance analyzer 405 of FIG. 4 determines whether the performance parameters contain any contiguous set(s) of frequencies and/or DSL sub-carriers (block 510). If no such degraded set of frequencies and/or DSL sub-carriers are identified (block 515), control proceeds to block 520 to determine if there are more subscriber lines to be analyzed.

If one or more degraded sets of frequencies and/or DSL sub-carriers are identified (block 515), the example thresholder 415 of FIG. 4 compares the number of frequencies and/or DSL sub-carriers in each set to a threshold (e.g., forty) (block 518). If no set of degraded frequencies and/or DSL sub-carriers is large enough (block 518), control proceeds to block 520 to determine if there are more subscriber lines to be analyzed.

If at least one set of degraded frequencies and/or DSL sub-carriers is indicative that the presently considered subscriber line may be imbalanced (block 518), the example AM interference source analyzer 415 of FIG. 4 correlates the set(s) of degraded frequencies and/or DSL sub-carriers with the operating and/or broadcast frequency(-ies) of any nearby and/or geographically proximate AM interference source(s) (block 525). If one or more sets of degraded frequencies and/or DSL sub-carriers correspond to a nearby AM interference source (block 530), the example trouble ticket submitter 310 of FIG. 3 submits a trouble ticket for the presently considered subscriber line to the example trouble ticket system 145 of FIG. 1. If there are more subscriber lines to analyze (block 520), control returns to block 505 to analyze the next subscriber line. If all subscriber lines have been analyzed (block 520), control exits from the example machine accessible instructions of FIG. 5.

Returning to block 530, if no set of degraded frequencies and/or DSL sub-carriers corresponds to a nearby AM interference source (block 530), control proceeds to block 520 without submitting a trouble ticket.

FIG. 6 is a schematic diagram of an example processor platform 9000 that may be used and/or programmed to implement all or a portion of any or all of the example DSL diagnostic tool 130, the example database interface module 305, the example trouble ticket submitter 310, the example data analysis module 315, the example scheduler 320, the example line performance analyzer 405, the example thresholder 410, the example AM interference source analyzer 415 and/or the example location table 420 of FIGS. 1, 3, and/or 4. For example, the processor platform 9000 can be implemented by one or more general purpose processors, processor cores, microcontrollers, etc.

The processor platform 9000 of the example of FIG. 6 includes at least one general purpose programmable processor 9005. The processor 9005 executes coded instructions 9010 and/or 9012 present in main memory of the processor 9005 (e.g., within a RAM 9015 and/or a ROM 9020). The processor 9005 may be any type of processing unit, such as a processor core, a processor and/or a microcontroller. The processor 9005 may execute, among other things, the example machine accessible instructions of FIG. 5 to implement the example methods and apparatus described herein.

The processor 9005 is in communication with the main memory (including a ROM 9020 and/or the RAM 9015) via a bus 9025. The RAM 9015 may be implemented by DRAM, SDRAM, and/or any other type of RAM device, and ROM may be implemented by flash memory and/or any other desired type of memory device. Access to the memory 9015 and the memory 9020 may be controlled by a memory controller (not shown). One or both of the example memories 9015 and 9020 may be used to implement the example DSL performance database 140 of FIG. 1 and/or the example location table 420 of FIG. 4.

The processor platform 9000 also includes an interface circuit 9030. The interface circuit 9030 may be implemented by any type of interface standard, such as an external memory interface, serial port, general purpose input/output, etc. One or more input devices 9035 and one or more output devices 9040 are connected to the interface circuit 9030. The input devices 9035 and/or output devices 9040 may be used to, for example, implement the example database interface module 305 and/or the example trouble ticket submitter 310 of FIG. 3.

Of course, the order, size, and proportions of the memory illustrated in the example systems may vary. Additionally, although this patent discloses example systems including, among other components, software or firmware executed on hardware, such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, the above described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of the invention are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method comprising:
identifying a contiguous set of performance parameters in a plurality of performance parameters for respective ones of a plurality of digital subscriber line (DSL) sub-carriers of a subscriber line associated with a DSL modem, the identified set have values representative of degraded performance and corresponding to an operating frequency of a geographically proximate AM interference source; and
comparing a number of DSL sub-carriers contained in the identified set with a threshold to determine whether the subscriber line has an imbalanced condition.

2. A method as defined in claim 1, further comprising automatically generating a trouble ticket for the subscriber line when the subscriber line has the imbalanced condition.

3. A method as defined in claim 1, further comprising retrieving the plurality of performance parameters from the DSL modem.

4. A method as defined in claim 1, wherein the imbalanced condition comprises at least one of a defective customer premises cable, a defective outside plant cable, a bad connector, a bonding problem or a grounding problem.

5. A method as defined in claim 1, further comprising at least one of installing a common-mode choke, installing an inline filter, replacing a cable, grounding the subscriber loop, repairing a connection, or replacing a connector to repair the imbalanced condition.

6. A method as defined in claim 1, wherein the identified set of the plurality of performance parameters is larger than if the subscriber line did not have the imbalanced condition.

7. A method as defined in claim 1, wherein a value representative of degraded performance comprises a value indicating that the subscriber line can not carry data at a corresponding frequency.

8. A method as defined in claim 1, wherein the method is repeated for a second DSL modem associated with a second subscriber line.

9. A method as defined in claim 1, wherein the method is performed on a scheduled basis to proactively identify the imbalanced condition.

10. A method as defined in claim 1, wherein the plurality of performance parameters for respective ones of the plurality of transmission frequencies represent a plurality of a number of data bits assigned to respective ones of the transmission frequencies.

11. A method comprising:
identifying a contiguous set of performance parameters in a plurality of performance parameters for respective ones of a plurality of frequencies of a subscriber line associated with a digital subscriber line (DSL) modem, the identified set having values representative of both an AM radio interference and an imbalanced condition associated with the subscriber line; and
automatically generating a trouble ticket for the subscriber line when the identified set of performance parameters corresponds to an operating frequency of a geographically proximate AM interference source.

12. A method as defined in claim 11, further comprising retrieving the plurality of performance parameters from the DSL modem.

13. A method as defined in claim 11, wherein the imbalanced condition comprises at least one of a defective customer premises cable, a defective outside plant cable, a bad connector, a bonding problem or a grounding problem.

14. A method as defined in claim 11, further comprising at least one of installing a common-mode choke, installing an inline filter, replacing a cable, grounding the subscriber loop, repairing a connection, or replacing a connector to repair the imbalanced condition.

15. An apparatus comprising:
a database interface module to obtain a plurality of performance parameters for respective ones of a plurality of transmission frequencies of a subscriber loop associated with a digital subscriber line (DSL) modem;
a thresholder to determine whether a contiguous set of the plurality of performance parameters having degraded values corresponds to both AM interference and an imbalanced condition associated with the subscriber loop;
an AM source location analyzer to verify that the set of performance parameters corresponds to an operating frequency of an AM source transmitting in geographic proximity to the subscriber loop; and
a trouble ticket submitter to request a repair ticket for the subscriber loop when the identified set of performance parameters corresponds to the operating frequency of the AM source.

16. An apparatus as defined in claim 15, further comprising a line performance analyzer to identify the contiguous set of the plurality of performance parameters having the degraded values.

17. An apparatus as defined in claim 15, further comprising a location table to store a plurality of AM interference operating frequencies for respective ones of a plurality of AM interference transmission locations.

18. An apparatus as defined in claim 15, further comprising a scheduler to initiate the line performance analyzer, the thresholder, and the AM source location analyzer to detect the imbalanced condition.

19. An apparatus as defined in claim 15, wherein the imbalanced condition is caused by at least one of a defective customer premises cable, a defective outside plant cable, a bad connector, a bonding problem or a grounding problem.

20. An apparatus as defined in claim 15, wherein the identified set of the plurality of performance parameters is larger than if the subscriber loop did not have the associated imbalanced condition.

21. An apparatus as defined in claim 15, wherein the identified set of the plurality of performance parameters have values indicating that the subscriber line can not carry data at their respective frequencies.

22. An article of manufacture storing machine readable instructions which, when executed, cause a machine to:
identify a contiguous set of performance parameters in a plurality of performance parameters for respective ones of a plurality of digital subscriber line (DSL) sub-carriers of a subscriber line associated with a DSL modem, the identified set have values representative of degraded performance and corresponding to an operating frequency of a geographically proximate AM interference source; and
compare a number of DSL sub-carriers contained in the identified set with a threshold to determine whether the subscriber line has an imbalanced condition.

23. An article of manufacture as defined in claim 22, wherein the machine readable instructions, when executed, cause the machine to automatically generate a trouble ticket for the subscriber line when the subscriber line has the imbalanced condition.

24. An article of manufacture as defined in claim 22, wherein the machine readable instructions, when executed, cause the machine to retrieve the plurality of performance parameters from the DSL modem.

25. An article of manufacture as defined in claim 22, wherein the imbalanced condition comprises at least one of a defective customer premises cable, a defective outside plant cable, a bad connector, a bonding problem or a grounding problem.
